(19) United States
(12) Patent Application Publication
(10) Pub. No.: US 2009/0009483 A1
(43) Pub. Date: Jan. 8, 2009

(54) SINGLE-CHIP TOUCH CONTROLLER WITH INTEGRATED DRIVE SYSTEM

(75) Inventors: Steve Porter Hotelling, San Jose, CA (US); Christoph Horst Krah, Los Altos, CA (US); Marduke Yousefpor, San Jose, CA (US); Thomas James Wilson, Pleasanton, CA (US)

Correspondence Address: APPLE C/O MORRISON AND FOERSTER ,LLP;LOS ANGELES, 555 WEST FIFTH STREET SUITE 3500, LOS ANGELES, CA, 90013-1024, US

(73) Assignee: Apple Inc., Cupertino, CA (US)

(21) Appl. No.: 12/208,334

(22) Filed: Sep. 10, 2008

Related U.S. Application Data
(63) Continuation-in-part of application No. 11/818,345, filed on Jun. 13, 2007.

(51) Int. Cl. G08C 21/00; G06F 3/041

(52) U.S. Cl. 345/173

(57) ABSTRACT

A touch controller for controlling a touch sensor panel is provided. The touch controller includes a plurality of sense channels that receive sensor signals from the touch sensor panel, a drive system that generates a plurality of stimulation signals based on a supply voltage on the order of digital logic level supply voltages, the stimulation signals for simultaneously stimulating multiple drive lines of the touch sensor panel, and a channel controller that controls the sense channels and the drive system. The plurality of sense channels, the drive system, and the channel controller are formed on a single chip.

### CROSS-REFERENCE TO RELATED APPLICATION

This application is a Continuation-In-Part (CIP) application of U.S. patent application Ser. No. 11/818,345, filed Jun. 13, 2007, which is incorporated herein by reference in its entirety for all purposes.

### FIELD OF THE INVENTION

This relates to control systems for touch sensor panels used as input devices for computing systems, and more particularly, to a single-chip touch controller with an integrated drive system for simultaneously stimulating multiple rows of a touch sensor panel with a plurality of stimulation signals.

### BACKGROUND OF THE INVENTION

Many types of input devices are presently available for performing operations in a computing system, such as buttons or keys, mice, trackballs, touch sensor panels, joysticks, touch screens and the like. Touch screens, in particular, are becoming increasingly popular because of their ease and versatility of operation as well as their declining price. Touch screens can include a touch sensor panel, which can be a clear panel with a touch-sensitive surface, and a display device that can be positioned behind the panel so that the touch-sensitive surface can substantially cover the viewable area of the display device. Touch screens can allow a user to perform various functions by touching the touch sensor panel using a finger, stylus or other object at a location dictated by a user interface (UI) being displayed by the display device. In general, touch screens can recognize a touch event and the position of the touch event on the touch sensor panel, and the computing system can then interpret the touch event in accordance with the display appearing at the time of the touch event, and thereafter can perform one or more actions based on the touch event.

Touch sensor panels can be formed from a matrix of row and column traces, with sensors or pixels present where the rows and columns cross over each other while being separated by a dielectric material. Each row can be driven by a stimulation signal, and touch locations can be identified because the charge injected into the columns due to the stimulation signal is proportional to the amount of touch. However, touch screens formed from capacitance-based touch sensor panels and display devices such as liquid crystal displays (LCDs) can suffer from noise problems because the voltage switching required to operate an LCD can capacitively couple onto the columns of the touch sensor panel and cause inaccurate measurements of touch. Furthermore, alternating current (AC) adapters used to power or charge the system can also couple noise into the touch screen. Other sources of noise can include switching power supplies in the system, backlight inverters, and light emitting diode (LED) pulse drivers. Each of these noise sources has a unique frequency and amplitude of interference that can change with respect to time.

In order to overcome these noise sources and achieve acceptable signal-to-noise ratios (SNR), conventional touch screen systems can require high voltage stimulation signals, which are generated using a high voltage system. The high voltage that can be required for the stimulation signal can force the control system of the sensor panel to be separated into two or more discrete chips. For example, in order to produce an acceptable SNR, conventional touch control circuitry can require a separate boost regulator chip and a separate high voltage driver chip for generating 18 volt stimulation signals, in addition to a separate chip for controlling and processing signals to/from the sensor panel.

### SUMMARY OF THE INVENTION

This relates to a single-chip touch controller with an integrated drive system for simultaneously stimulating multiple rows of a touch sensor panel with a plurality of stimulation signals. The single-chip design generates lower-voltage stimulation signals using lower-voltage circuitry, while maintaining an SNR above an acceptable threshold for obtaining a touch image. This can involve the use of multiple digital mixers to perform spectrum analysis to identify noise sources that enter the touch system through the sensor panel and select low noise stimulation frequencies, and to the use of one or more stimulation frequencies and phases to detect and localize touch events on a touch sensor panel. Each of a plurality of sense channels can be coupled to a column in a touch sensor panel and can have multiple mixers. Each mixer in each sense channel can utilize a circuit capable of being controlled to generate a demodulation frequency of a particular frequency, phase and delay.

When performing a spectrum analyzer function, no stimulation signal is applied to any of the rows in the touch sensor panel. The sum of the output of all sense channels, which can represent the total charge being applied to the touch sensor panel including all detected noise, can be fed back to each of the mixers in each sense channel. The mixers can be paired up, and each pair of mixers can demodulate the sum of all sense channels using the in-phase (I) and quadrature (Q) signals of a particular frequency. The demodulated outputs of each mixer pair can be used to calculate the magnitude of the noise at that particular frequency, wherein the lower the magnitude, the lower the noise at that frequency. One or more low noise frequencies can be selected for use in a subsequent touch sensor panel scan function.

When performing the touch sensor panel scan function, at each of multiple steps, various phases of the selected low noise frequency or frequencies can be used to simultaneously stimulate the rows of the touch sensor panel, and the one or more mixers in each sense channel can be configured to demodulate the sensor signal received from the column connected to each sense channel using the selected low noise frequencies. The demodulated signals from the one or more mixers can then be saved. After all steps have been completed, the saved results can be used in calculations to determine an image of touch for the touch sensor panel at each frequency.

### BRIEF DESCRIPTION OF THE DRAWINGS

FIG. 1 illustrates an exemplary computing system that includes a single-chip touch controller with an integrated drive system for simultaneously stimulating multiple rows of a touch sensor panel with a plurality of stimulation signals according to one embodiment of this invention.

FIG. 2a illustrates an exemplary mutual capacitance touch sensor panel according to one embodiment of this invention.

FIG. 2b is a side view of an exemplary pixel in a steady-state (no-touch) condition according to one embodiment of this invention.

FIG. 2c is a side view of an exemplary pixel in a dynamic (touch) condition according to one embodiment of this invention.

FIG. 3a illustrates a portion of an exemplary sense channel or event detection and demodulation circuit according to one embodiment of this invention.

FIG. 3b illustrates a simplified block diagram of N exemplary sense channel or event detection and demodulation circuits according to one embodiment of this invention.

FIG. 3c illustrates an exemplary block diagram of 10 sense channels that can be configured either as a spectrum analyzer or as panel scan logic according to one embodiment of this invention.

FIG. 3d illustrates a simplified block diagram of N exemplary sense channel or event detection and demodulation circuits according to another embodiment of this invention.

FIG. 3e illustrates an exemplary block diagram of 10 sense channels that can be configured either as a spectrum analyzer or as panel scan logic according to another embodiment of this invention.

FIG. 4a illustrates an exemplary timing diagram showing an LCD phase and touch sensor panel phase according to one embodiment of this invention.

FIG. 4b illustrates an exemplary flow diagram describing the LCD phase and the touch sensor panel phase according to one embodiment of this invention.

FIG. 4c illustrates an exemplary capacitive scanning plan according to one embodiment of this invention.

FIG. 4d illustrates exemplary calculations for a particular channel M to compute full image results at different low noise frequencies according to one embodiment of this invention.

FIG. 5a illustrates an exemplary mobile telephone that can include a single-chip touch controller with an integrated drive system for simultaneously stimulating multiple rows of a touch sensor panel with a plurality of stimulation signals according to one embodiment of this invention.

FIG. 5b illustrates an exemplary digital audio player that can include a single-chip touch controller with an integrated drive system for simultaneously stimulating multiple rows of a touch sensor panel with a plurality of stimulation signals according to one embodiment of this invention.

### DETAILED DESCRIPTION OF THE PREFERRED EMBODIMENT

In the following description of preferred embodiments, reference is made to the accompanying drawings which form a part hereof, and in which it is shown by way of illustration specific embodiments in which the invention can be practiced. It is to be understood that other embodiments can be used and structural changes can be made without departing from the scope of the embodiments of this invention.

This relates to a single-chip touch controller with an integrated drive system. In contrast to previous designs, which can require the use of a separate high voltage system to generate high voltage stimulation signals to overcome noise and achieve an SNR above an acceptable threshold for obtaining a touch image, embodiments of the invention maintain an acceptable SNR using lower-voltage stimulation signals to stimulate multiple rows of a touch sensor panel at the same time. The lower-voltage circuitry used to generate the lower-voltage stimulation signals can be formed on the same chip as other components for controlling and processing signals to/from the sensor panel. Some embodiments of the invention can involve the use of multiple digital mixers to perform spectrum analysis of noise to identify low noise stimulation frequencies, and the use of one or more stimulation frequencies and phases to detect and localize touch events on a touch sensor panel. Each of a plurality of sense channels can be coupled to a column in a touch sensor panel and can have one or more mixers. Each mixer in the sense channel can utilize a circuit capable of being controlled to generate a demodulation frequency of a particular frequency, phase and delay.

When performing a spectrum analyzer function, no stimulation signal is applied to any of the rows in the touch sensor panel. The sum of the output of all sense channels, which can represent the total charge being applied to the touch sensor panel including all detected noise, can be fed back to each of the mixers in the sense channels. The mixers can be paired up, and each pair of mixers can demodulate the sum of all sense channels using the in-phase (I) and quadrature (Q) signals of a particular frequency. The demodulated outputs of each mixer pair can be used to calculate the magnitude of the noise at that particular frequency, wherein the lower the magnitude, the lower the noise at that frequency. One or more low noise frequencies can be selected for use in a subsequent touch sensor panel scan function.

When performing the touch sensor panel scan function, at each of multiple steps, various phases of the selected low noise frequency or frequencies can be used to simultaneously stimulate the rows of the touch sensor panel, and the one or more mixers in each sense channel can be configured to demodulate the sensor signal received from the column connected to each sense channel using the selected low noise frequencies. The demodulated signals from the one or more mixers can then be saved. After all steps have been completed, the saved results can be used in calculations to determine an image of touch for the touch sensor panel at each frequency.

For a single stimulus drive and a given noise voltage level VNZ the Signal-To-Noise-Ratio for a given stimulus voltage level VSTM_{SS} per pixel is:

$${SNR}_{SS} \approx 10 \cdot LOG ( \frac{{PSTM}_{SS}}{{PNZ}_{SS}} ) = 20 \cdot LOG ( \frac{{VSTM}_{SS}}{{VNZ}_{SS}} )$$

For a multi-stimulus drive and a given noise voltage level VNZ_{MS} the Signal-To-Noise-Ratio for a given stimulus voltage level VSTM_{MS} per pixel is:

$${SNR}_{MS} \approx 10 \cdot LOG ( \frac{{PSTM}_{MS}}{{PNZ}_{MS}} ) = 20 \cdot LOG ( \frac{{VSTM}_{MS}}{{VNZ}_{MS}} )$$

Due to the stimulus drive voltage levels involved (typically 18V) the high voltage driver function typically has to be implemented as a separate ASIC that can handle the voltage levels involved. In order to integrate the high voltage driver function into the touch controller, the stimulus voltage VSTM_{SS} has to be reduced to a level that the single ASIC touch controller can handle. In one embodiment, the single ASIC touch controller may be implemented in a 90 nm process. In such process, voltages as high as 3.6V are possible, however, by cascading transistors it is possible to reach drive voltage levels up to 6V, for example.

For a given sensor panel, a certain number of rows N and columns M are assumed. In a single stimulus drive scheme one of the rows is stimulated at a given time, i.e. for each scan or frame N rows are stimulated in sequence, i.e. each rows is stimulated for approximately TROW_{SS}=TSCAN/N. Here TROW_{SS} is the scan time for a single row, and TSCAN is the time to acquire an entire frame of touch data. Since the multi-stim controller should meet the same noise level requirement as the single-stim controller subsystem:

$${SNR}_{MS} \geq {SNR}_{SS} 20 \cdot LOG ( \frac{{VSTM}_{MS}}{{VNZ}_{MS}} ) \geq 20 \cdot LOG ( \frac{{VSTM}_{SS}}{{VNZ}_{SS}} )$$

After solving this equation for VSTM_{MS}:

$${VNZ}_{MS} = {VNZ}_{SS} \cdot \frac{{VSTM}_{MS}}{{VSTM}_{SS}} \to \frac{{VNZ}_{MS}}{{VNZ}_{SS}} = \frac{{VSTM}_{MS}}{{VSTM}_{SS}} = NZRAT \qquad Equation 1$$

Here NZRAT is the noise ratio, i.e. the factor by which the noise of the multi-stim touch ASIC should be reduced to meet the SNR of the single stim touch controller.
This means, for a single chip controller the noise level needs to be lower in order to meet the same SNR. For example, for VNZ_{MS}=5V and VSTM_{SS}=18V the noise level VNZ_{MS} needs to be lower by a factor of 18V/5V=3.6 to meet the same noise performance.

One way to gain increase noise performance can be further integrating the noise over multiple steps. Assuming a gaussian shaped noise source VNZ, the amount noise VNZ_{INT} after integration is a function of the number of samples N_{SS} over which the noise VNZ is integrated.

$$\frac{VNZ}{{VNZ}_{INT}} \sqrt{{N}_{SS}} = NZF \qquad Equation 2$$

Equating equations 1 and 2:

$$= \sqrt{{N}_{SS}} {N}_{SS} = {( \frac{{VSTM}_{MS}}{{VSTM}_{SS}} )}^{2}$$

Therefore, this means that if the same noise performance for single stimulus controller is desired at a lower stimulus voltage level (e.g. 5V), then at least 3.6̂2 more time is needed, e.g. the frame rate TSCAN would increase by a factor of 12, which is not desirable. Therefore to maintain the same frame rate TSCAN, at least 12 rows need to be stimulated at the time time for each step. This will enable the integration of the charge of a single pixel across the entire frame period TSCAN.

Although some embodiments of this invention may be described herein in terms of mutual capacitance touch sensors, it should be understood that embodiments of this invention are not so limited, but are generally applicable to other types of touch sensors such as self capacitance touch sensors. Furthermore, although the touch sensors in the touch sensor panel may be described herein in terms of an orthogonal array of touch sensors having rows and columns, it should be understood that embodiments of this invention are not limited to orthogonal arrays, but can be generally applicable to touch sensors arranged in any number of dimensions and orientations, including diagonal, concentric circle, and three-dimensional and random orientations. In addition, the touch sensor panel described herein can be either a single-touch or a multi-touch sensor panel, the latter of which is described in Applicant's co-pending U.S. application Ser. No. 10/840,862 entitled “Multipoint Touchscreen,” filed on May 6, 2004 and published as U.S. Published Application No. 2006/0097991 on May 11, 2006, the contents of which are incorporated by reference herein.

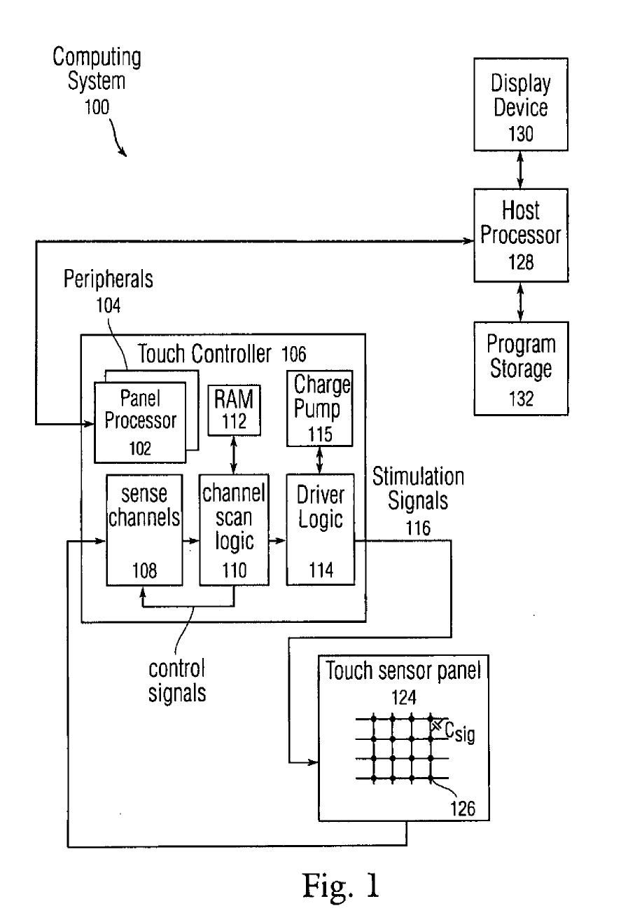

FIG. 1 illustrates exemplary computing system 100 that utilizes a single-chip touch controller 106 with integrated drive system according to embodiments of the invention. Touch controller 106 is a single application specific integrated circuit (ASIC) that can include one or more panel processors 102 and peripherals 104. One or more panel processors 102 can include, for example, ARM968 processors or other processors with similar functionality and capabilities. However, in other embodiments, the panel processor functionality can be implemented instead by dedicated logic, such as a state machine. Peripherals 104 can include, but are not limited to, random access memory (RAM) or other types of memory or storage, watchdog timers and the like. Touch controller 106 can also include, but is not limited to, one or more sense channels 108, a channel controller such as channel scan logic 110 and a drive system such as driver logic 114. Channel scan logic 110 can access RAM 112, autonomously read data from the sense channels and provide control for the sense channels. In addition, channel scan logic 110 can control driver logic 114 to generate stimulation signals 116 at various frequencies and phases that can be selectively applied to rows of touch sensor panel 124.

Touch sensor panel 124 can include a capacitive sensing medium having a plurality of row traces or driving lines and a plurality of column traces or sensing lines, although other sensing media can also be used. The row and column traces can be formed from a transparent conductive medium such as Indium Tin Oxide (ITO) or Antimony Tin Oxide (ATO), although other transparent and non-transparent materials such as copper can also be used. In some embodiments, the row and column traces can be perpendicular to each other, although in other embodiments other non-Cartesian orientations are possible. For example, in a polar coordinate system, the sensing lines can be concentric circles and the driving lines can be radially extending lines (or vice versa). It should be understood, therefore, that the terms “row” and “column,” “first dimension” and “second dimension,” or “first axis” and “second axis” as used herein are intended to encompass not only orthogonal grids, but the intersecting traces of other geometric configurations having first and second dimensions (e.g. the concentric and radial lines of a polar-coordinate arrangement). The rows and columns can be formed on a single side of a substantially transparent substrate separated by a substantially transparent dielectric material, on opposite sides of the substrate, or on two separate substrates separated by the dielectric material.

At the “intersections” of the traces, where the traces pass above and below (cross) each other (but do not make direct electrical contact with each other), the traces can essentially form two electrodes (although more than two traces could intersect as well). Each intersection of row and column traces can represent a capacitive sensing node and can be viewed as picture element (pixel) 126, which can be particularly useful when touch sensor panel 124 is viewed as capturing an “image” of touch. (In other words, after touch controller 106 has determined whether a touch event has been detected at each touch sensor in the touch sensor panel, the pattern of touch sensors in the multi-touch panel at which a touch event occurred can be viewed as an “image” of touch (e.g. a pattern of fingers touching the panel).) The capacitance between row and column electrodes appears as a stray capacitance when the given row is held at direct current (DC) voltage levels and as a mutual signal capacitance Csig when the given row is stimulated with an alternating current (AC) signal. The presence of a finger or other object near or on the touch sensor panel can be detected by measuring changes to a signal charge Qsig present at the pixels being touched, which is a function of Csig. Each column of touch sensor panel 124 can drive sense channel 108 (also referred to herein as an event detection and demodulation circuit) in touch controller 106.

Computing system 100 can also include host processor 128 for receiving outputs from panel processor 102 and performing actions based on the outputs that can include, but are not limited to, moving an object such as a cursor or pointer, scrolling or panning, adjusting control settings, opening a file or document, viewing a menu, making a selection, executing instructions, operating a peripheral device connected to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 128 can also perform additional functions that may not be related to panel processing, and can be coupled to program storage 132 and display device 130 such as an LCD display for providing a UI to a user of the device.

As mentioned above, in some systems, sensor panel 124 can be driven by high-voltage driver logic. The high voltages that can be required by the high-voltage driver logic (e.g. 18V) can force the high-voltage driver logic to be formed separate from touch controller 106, which can operate at much lower digital logic voltage levels (e.g. 1.7 to 3.3V). However, in embodiments of the invention, a drive system that generates stimulation signals based on a supply voltage on the order of digital logic level supply voltages, such as on-chip driver logic 114, can replace the off-chip high voltage driver logic. In some embodiments, touch controller 106 can have low, digital logic level supply voltages that supply the drive system. In some other embodiments, the drive system can generate a supply voltage greater than the digital logic level supply voltages by cascading two transistors together to form charge pump 115. Charge pump 115 can be used to generate stimulation signals 116 (Vstim) that can have amplitudes of about twice the digital logic level supply voltages (e.g. 3.4 to 6.6V). Although FIG. 1 shows charge pump 115 separate from driver logic 114, the charge pump can be part of the driver logic.

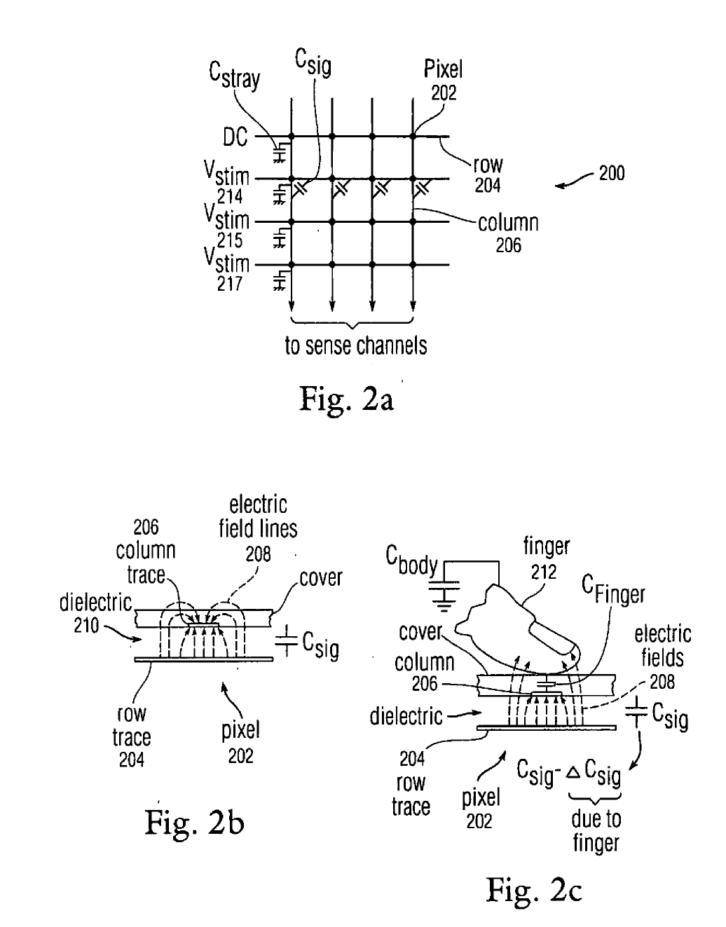

FIG. 2a illustrates exemplary mutual capacitance touch sensor panel 200 according to embodiments of the invention. FIG. 2a indicates the presence of a stray capacitance Cstray at each pixel 202 located at the intersection of a row 204 and a column 206 trace (although Cstray for only one column is illustrated in FIG. 2a for purposes of simplifying the figure). In the example of FIG. 2a, AC stimuli Vstim 214, Vstim 215 and Vstim 217 can be applied to several rows, while other rows can be connected to DC. Vstim 214, Vstim 215 and Vstim 217 can be, for example, signals having the same or different frequencies and different phases, as will be explained later. Each stimulation signal on a row can cause a charge Qsig=Csig×Vstim to be injected into the columns through the mutual capacitance present at the affected pixels. A change in the injected charge (Qsig_sense) can be detected when a finger, palm or other object is present at one or more of the affected pixels. Vstim signals 214, 215 and 217 can include one or more bursts of sine waves. Note that although FIG. 2a illustrates rows 204 and columns 206 as being substantially perpendicular, they need not be so aligned, as described above. As described above, each column 206 can be connected to a sense channel (see sense channels 108 in FIG. 1).

FIG. 2b is a side view of exemplary pixel 202 in a steady-state (no-touch) condition according to embodiments of the invention. In FIG. 2b, an electric field of electric field lines 208 of the mutual capacitance between column 206 and row 204 traces or electrodes separated by dielectric 210 is shown.

FIG. 2c is a side view of exemplary pixel 202 in a dynamic (touch) condition. In FIG. 2c, finger 212 has been placed near pixel 202. Finger 212 is a low-impedance object at signal frequencies, and has an AC capacitance Cfinger from the column trace 204 to the body. The body has a self-capacitance to ground Cbody of about 200 pF, where Cbody is much larger than Cfinger. If finger 212 blocks some electric field lines 208 between the row and column electrodes (those fringing fields that exit the dielectric and pass through the air above the row electrode), those electric field lines are shunted to ground through the capacitance path inherent in the finger and the body, and as a result, the steady state signal capacitance Csig is reduced by ΔCsig. In other words, the combined body and finger capacitance act to reduce Csig by an amount ΔCsig (which can also be referred to herein as Csig_sense), and can act as a shunt or dynamic return path to ground, blocking some of the electric fields as resulting in a reduced net signal capacitance. The signal capacitance at the pixel becomes Csig-ΔCsig, where Csig represents the static (no touch) component and ΔCsig represents the dynamic (touch) component. Note that Csig-ΔCsig may always be nonzero due to the inability of a finger, palm or other object to block all electric fields, especially those electric fields that remain entirely within the dielectric material. In addition, it should be understood that as a finger is pushed harder or more completely onto the multi-touch panel, the finger can tend to flatten, blocking more and more of the electric fields, and thus ΔCsig can be variable and representative of how completely the finger is pushing down on the panel (i.e. a range from “no-touch” to “full-touch”).

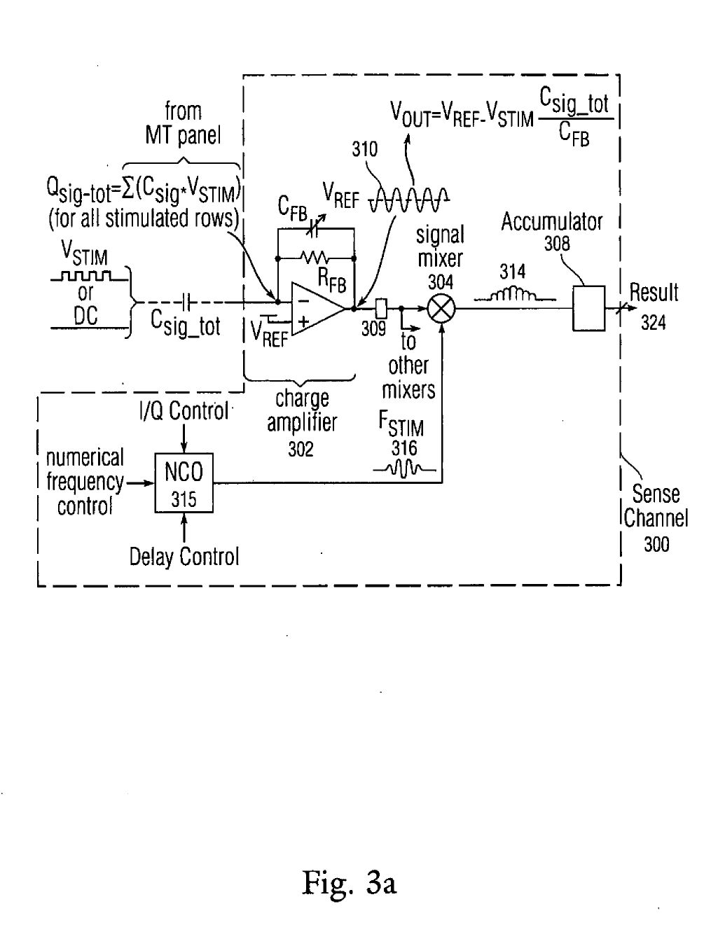

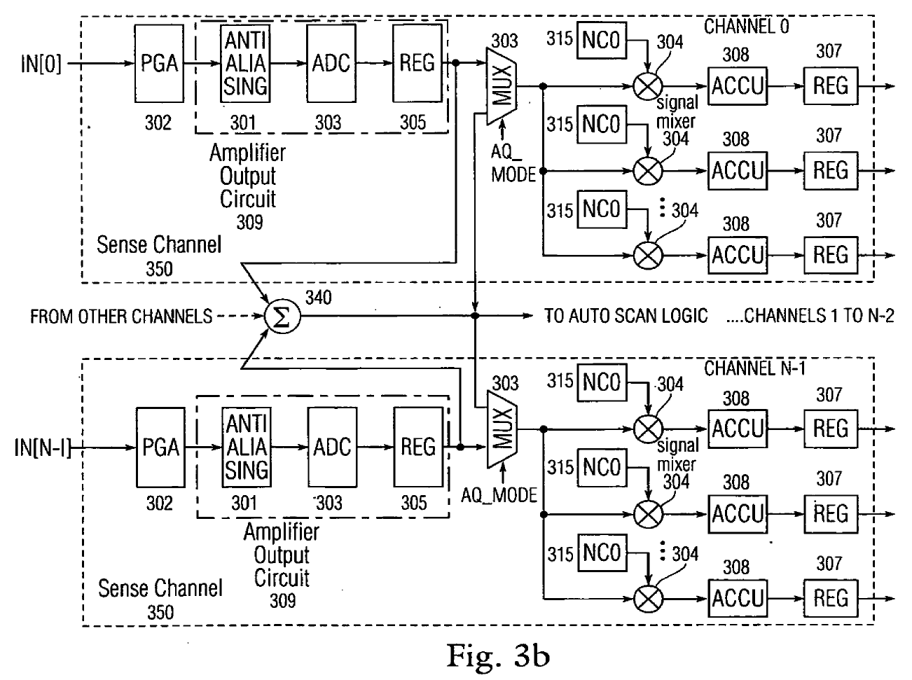

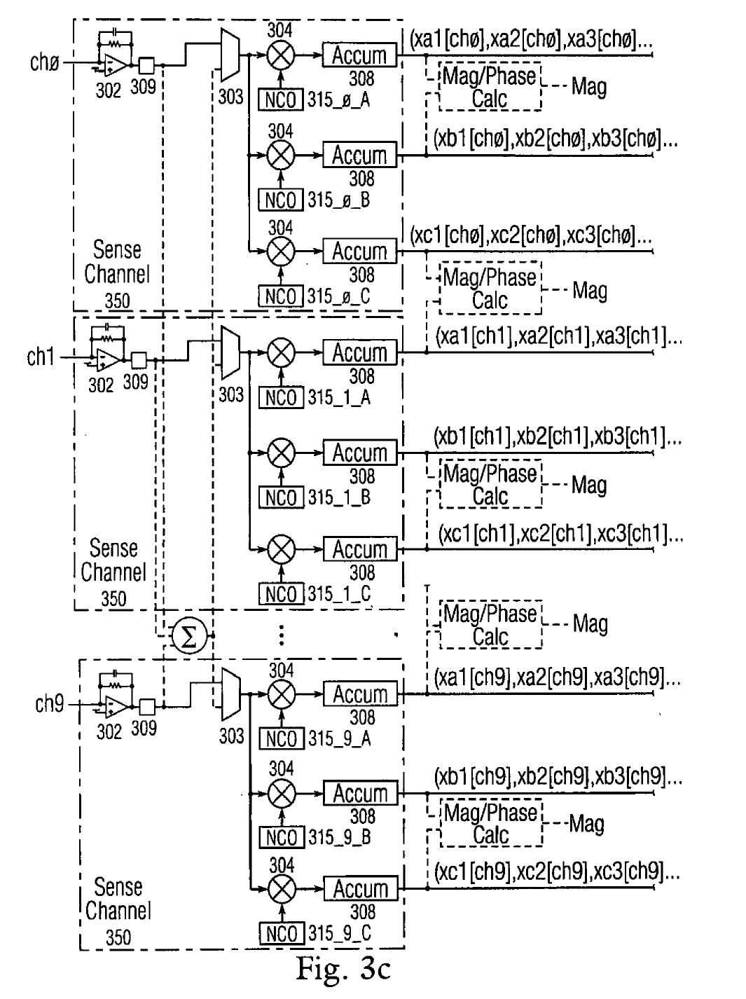

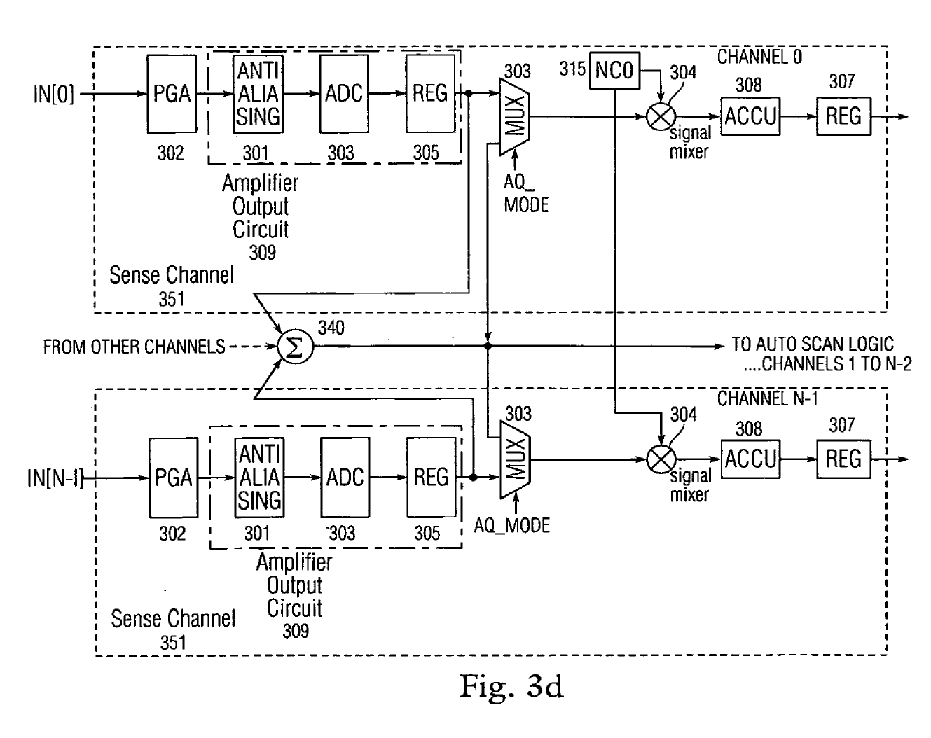

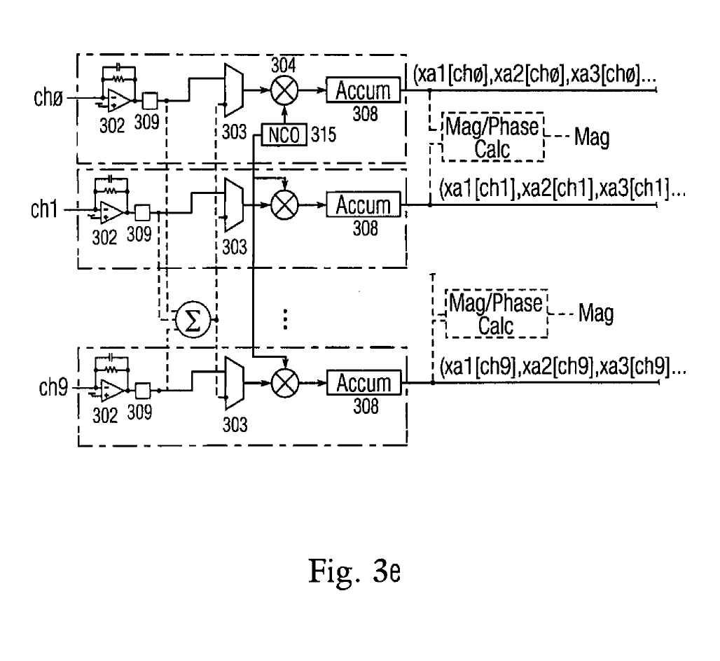

FIG. 3a illustrates a portion of exemplary sense channel or event detection and demodulation circuit 300 according to embodiments of the invention. One or more sense channels 300 can be present in the touch controller. Each column from a touch sensor panel can be connected to sense channel 300. Each sense channel 300 can include virtual-ground amplifier 302, amplifier output circuit 309 (to be explained in greater detail below), signal mixer 304, and accumulator 308. Note that, in some embodiments, amplifier output circuit 309 can also be connected to other signal mixers and associated circuitry not shown in FIG. 3a to simplify the figure.

Virtual-ground amplifier 302, which can also be referred to as a DC amplifier or a charge amplifier, can include feedback capacitor Cfb and feedback resistor Rfb. Because of the much smaller amount of charge that can be injected into a row due to lower Vstim amplitudes, Cfb could be made much smaller than in some previous designs if, for example, only a few rows are stimulated at a time. However, by stimulating most or all rows at the same time, the integration of the charge contribution for a given pixel can be extended across the entire frame period, effectively allowing the increase of integration time by a factor equivalent to the number of stimulated rows as described above. This multi-stimulus approach can increase the SNR of the system, as explained in more detail below. Because most or all rows are simultaneously stimulated, which tends to add charge, Cfb is not reduced in size.

FIG. 3a shows, in dashed lines, the total steady-state signal capacitance Csig_tot that can be contributed by a touch sensor panel column connected to sense channel 300 when input stimuli Vstim are applied to the rows in the touch sensor panel and no finger, palm or other object is present. In a steady-state, no-touch condition, the total signal charge Qsig_tot injected into the column is the sum of all charge injected into the column by each stimulated row. In other words, Qsig_tot=S(Csig*Vstim for all stimulated rows). Each sense channel coupled to a column can detect any change in the total signal charge due to the presence of a finger, palm or other body part or object at one or more pixels in that column. In other words, Qsig_tot_sense=S((Csig−Csig_sense)*Vstim for all stimulated rows).

As noted above, there can be an inherent stray capacitance Cstray at each pixel on the touch sensor panel. In virtual ground charge amplifier 302, with the +(noninverting) input tied to reference voltage Vref, the—(inverting) input can also be driven to Vref, and a DC operating point can be established. Therefore, regardless of how much Csig is present at the input to virtual ground charge amplifier 302, the—input can always be driven to Vref. Because of the characteristics of virtual ground charge amplifier 302, any charge Qstray that is stored in Cstray is constant, because the voltage across Cstray is kept constant by the charge amplifier. Therefore, no matter how much stray capacitance Cstray is added to the—input, the net charge into Cstray will always be zero. The input charge is accordingly zero when the corresponding row is kept at DC and is purely a function of Csig and Vstim when the corresponding row is stimulated. In either case, because there is no charge across Csig, the stray capacitance is rejected, and it essentially drops out of any equations. Thus, even with a hand over the touch sensor panel, although Cstray can increase, the output will be unaffected by the change in Cstray.

The gain of virtual ground amplifier 302 can be small (e.g. 0.1) and can be computed as the ratio of Csig_tot and feedback capacitor Cfb. The adjustable feedback capacitor Cfb can convert the charge Qsig to the voltage Vout. The output Vout of virtual ground amplifier 302 is a voltage that can be computed as the ratio of −Csig/Cfb multiplied by Vstim referenced to Vref. The Vstim signaling can therefore appear at the output of virtual ground amplifier 302 as signals having a much smaller amplitude. However, when a finger is present, the amplitude of the output can be even further reduced, because the signal capacitance is reduced by ΔCsig. The output of charge amplifier 302 is the superposition of all row stimulus signals multiplied by each of the Csig values on the column associated with that charge amplifier. A column can have some pixels which are driven by a frequency at positive phase, and simultaneously have other pixels which are driven by that same frequency at negative phase (or 180 degrees out of phase). In this case, the total component of the charge amplifier output signal at that frequency can be the amplitude and phase associated with the sum of the product of each of the Csig values multiplied by each of the stimulus waveforms. For example, if two rows are driven at positive phase, and two rows are driven at negative phase, and the Csig values are all equal, then the total output signal will be zero. If the finger gets near one of the pixels being driven at positive phase, and the associated Csig reduces, then the total output at that frequency will have negative phase.

Vstim, as applied to a row in the touch sensor panel, can be generated as a burst of sine waves (e.g. sine waves with smoothly changing amplitudes in order to be spectrally narrow) or other non-DC signaling in an otherwise DC signal, although in some embodiments the sine waves representing Vstim can be preceded and followed by other non-DC signaling. If Vstim is applied to a row and a signal capacitance is present at a column connected to sense channel 300, the output of charge amplifier 302 associated with that particular stimulus can be sine wave train 310 centered at Vref with a peak-to-peak (p-p) amplitude in the steady-state condition that can be a fraction of the p-p amplitude of Vstim, the fraction corresponding to the gain of charge amplifier 302. For example, if Vstim includes 6.6V p-p sine waves and the gain of the charge amplifier is 0.1, then the output of the charge amplifier associated with this row can be approximately 0.67V p-p sine wave. In should be noted that the signal from all rows are superimposed at the output of the preamp. The analog output from the preamp is converted to digital in block 309. The output from 309 can be mixed in digital signal mixer 304 (which is a digital multiplier) with demodulation waveform Fstim 316.

Because Vstim can create undesirable harmonics, especially if formed from square waves, demodulation waveform Fstim 316 can be a Gaussian shaped sine wave that can be digitally generated from numerically controlled oscillator (NCO) 315 and synchronized to Vstim. It should be understood that in addition to one or more NCOs 315, which are used for digital demodulation, independent NCOs can be connected to digital-to-analog converters (DACs), such as a thermometer coded DAC, an R2R DAC, a sigma-delta data converter, etc., whose outputs can be optionally inverted and used as the row stimulus. NCO 315 can include a numerical control input to set the output frequency, a control input to set the delay, and a control input to enable the NCO to generate an in-phase (I) or quadrature (Q) signal. Signal mixer 304 can demodulate the output of charge amplifier 310 by subtracting Fstim 316 from the output to provide better noise rejection. Signal mixer 304 can reject all frequencies outside the passband, which can in one example be about +/−30 kHz around Fstim. This noise rejection can be beneficial in noisy environment with many sources of noise, such as 802.11, Bluetooth and the like, all having some characteristic frequency that can interfere with the sensitive (femtofarad level) sense channel 300. For each frequency of interest being demodulated, signal mixer 304 is essentially a synchronous rectifier as the frequency of the signal at its inputs is the same, and as a result, signal mixer output 314 is essentially a rectified Gaussian sine wave.

FIG. 3b illustrates a simplified block diagram of N exemplary sense channel or event detection and demodulation circuits 350, each of which could be, for example, a sense channel 300 in FIG. 3a, according to embodiments of the invention. As noted above, each charge amplifier or programmable gain amplifier (PGA) 302 in sense channel 350 can be connected to amplifier output circuit 309, which in turn can be connected to R signal mixers 304 through multiplexer 303. Amplifier output circuit 309 can include anti-aliasing filter 301, ADC 303 (for example, a sigma-delta data converter, a successive-approximation-register (SAR) ADC, etc.), and result register 305. Each signal mixer 304 can be demodulated with a signal from a separate NCO 315. The demodulated output of each signal mixer 304 can be connected to a separate accumulator 308 and results register 307.

It should be understood that PGA 302, which may have detected a higher amount of charge generated from a high-voltage Vstim signal (e.g. 18V) in previous designs, can now detect a lower amount of charge generated from a lower voltage Vstim signal (e.g. 6.6V). Furthermore, NCOs 315 can cause the output of charge amplifier 302 to be demodulated simultaneously yet differently, because each NCO 310 can generate signals at different frequencies, delays and phases. Each signal mixer 304 in a particular sense channel 350 can therefore generate an output representative of roughly one-Rth the charge of previous designs, but because there are R mixers, each demodulating at a different frequency, each sense channel can still detect about the same total amount of charge as in previous designs.

In FIG. 3b, signal mixers 304 and accumulators 308 can be implemented digitally instead of in analog circuitry inside an ASIC. Having the mixers and accumulators implemented digitally instead of in analog circuitry inside the ASIC can save die space (e.g. about 15% in some embodiments).

FIG. 3c illustrates an exemplary block diagram of 10 sense channels 350 that can be configured either as a spectrum analyzer or as panel scan logic according to embodiments of the invention. In the example of FIG. 3c, each of 10 sense channels 350 can be connected to a separate column in a touch sensor panel. Note that each sense channel 350 can include multiplexer or switch 303, to be explained in further detail below. The solid-line connections in FIG. 3c can represent the sense channels configured as panel scan logic, and the dashed-line connections can represent the sense channels configured as a spectrum analyzer. FIG. 3c will be discussed in greater detail hereinafter.

FIG. 3d illustrates a simplified block diagram of another N exemplary sense channel or event detection and demodulation circuits 351, each of which could be, for example, a sense channel 300 in FIG. 3a, according to embodiments of the invention. Sense channels 351 are similar to sense channels 350, but each sense channel 351 has only one signal mixer 304. In addition, the signal mixers 304 of sense channels 351 share a single NCO 315. Thus, each charge amplifier or programmable gain amplifier (PGA) 302 in sense channel 351 can be connected to amplifier output circuit 309, which in turn can be connected to a signal mixer 304 through multiplexer 303. Amplifier output circuit 309 can include anti-aliasing filter 301, ADC 303, and result register 305. Each signal mixer 304 can be demodulated with a signal from the NCO 315. The demodulated output of each signal mixer 304 can be connected to a separate accumulator 308 and results register 307.

FIG. 3e illustrates an exemplary block diagram of 10 sense channels 351 that can be configured either as a spectrum analyzer or as panel scan logic according to embodiments of the invention. In the example of FIG. 3e, each of 10 sense channels 351 can be connected to a separate column in a touch sensor panel. Note that each sense channel 300 can include multiplexer or switch 303, to be explained in further detail below. The solid-line connections in FIG. 3e can represent the sense channels configured as panel scan logic, and the dashed-line connections can represent the sense channels configured as a spectrum analyzer. FIG. 3e will be discussed in greater detail hereinafter.

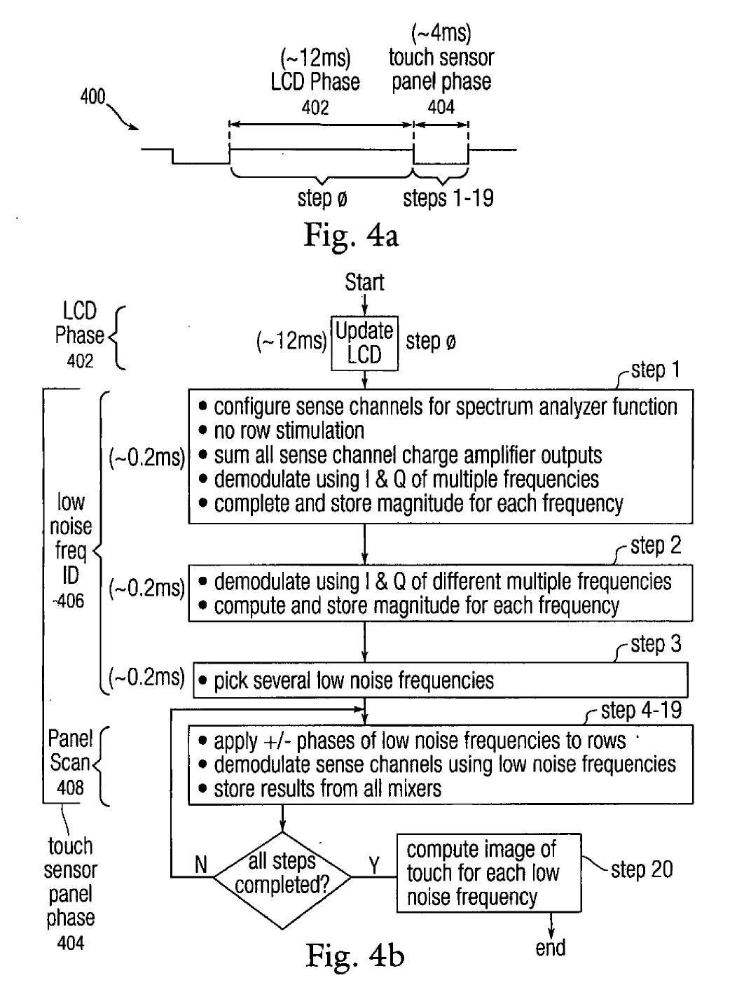

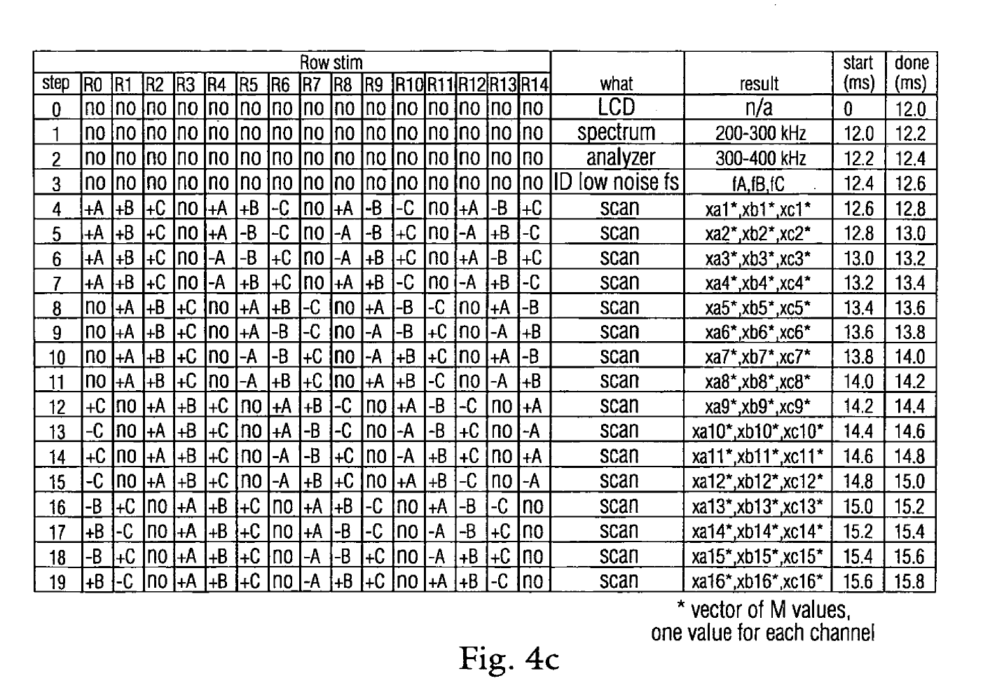

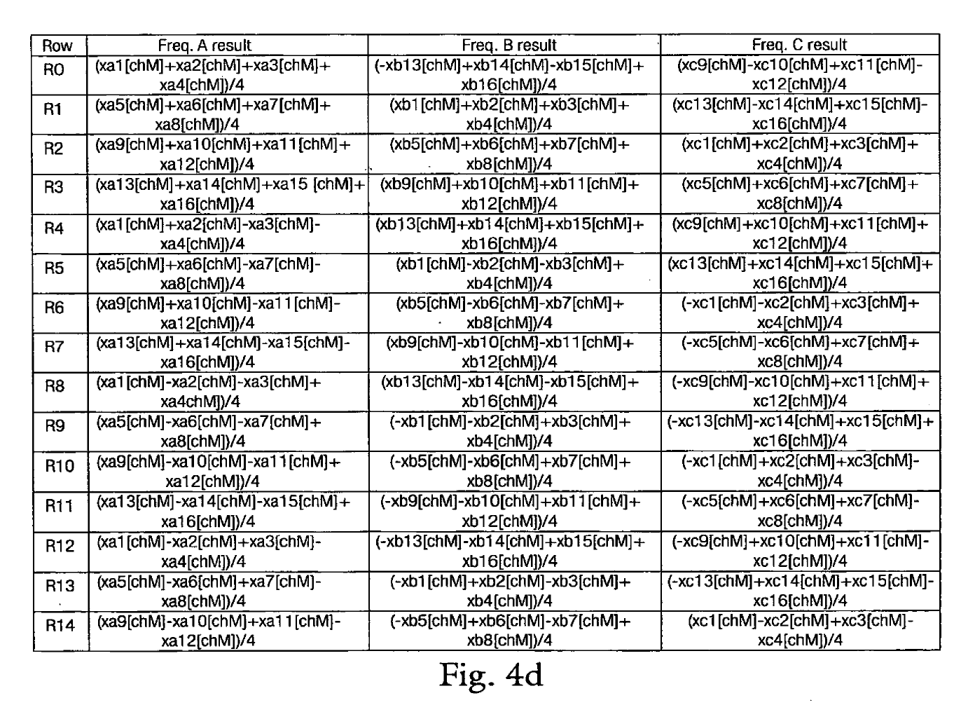

FIG. 4a illustrates exemplary timing diagram 400 showing LCD phase 402 and the vertical blanking or touch sensor panel phase 404 according to embodiments of the invention. During LCD phase 402, the LCD can be actively switching and can be generating voltages needed to generate images. No panel scanning is performed at this time. During touch sensor panel phase 404, the sense channels can be configured as a spectrum analyzer to identify low noise frequencies, and can also be configured as panel scan logic to detect and locate an image of touch.

FIG. 4b illustrates exemplary flow diagram 406 describing LCD phase 402 and touch sensor panel phase 404 corresponding to the examples of FIGS. 3c and 3e according to embodiments of the invention. In Step 0, the LCD can be updated as described above.

Steps 1-3 can represent a low noise frequency identification phase 406. In Step 1, the sense channels can be configured as a spectrum analyzer. The purpose of the spectrum analyzer is to identify one or more low noise frequencies for subsequent use in a panel scan. With no stimulation frequencies applied to any of the rows of the touch sensor panel, the sum of the output of all sense channels, which represent the total charge being applied to the touch sensor panel including all detected noise, can be fed back to each of the mixers in the sense channels. The mixers can be paired up, and each pair of mixers can demodulate the sum of all sense channels using the in-phase (I) and quadrature (Q) signals of a particular frequency. The demodulated outputs of each mixer pair can be used to calculate the magnitude of the noise at that particular frequency, wherein the lower the magnitude, the lower the noise at that frequency.

In Step 2, the process of Step 1 can be repeated for a different frequency or set of frequencies.

In Step 3, one or more low noise frequencies can be selected for use in a subsequent touch sensor panel scan by identifying those frequencies producing the lowest calculated magnitude value.

Steps 4-19 can represent a panel scan phase 408. In Steps 4-19, the sense channels can be configured as panel scan logic. At each of Steps 4-19, various phases of the selected low noise frequency or frequencies can be used to simultaneously stimulate the rows of the touch sensor panel, and the multiple mixers in each sense channel can be configured to demodulate the sensor signal received from the column connected to each sense channel using the selected low noise frequency or frequencies. The demodulated signals from the multiple mixers can then be saved.

In Step 20, after all steps have been completed, the saved results can be used in calculations to determine an image of touch for the touch sensor panel at the selected low noise frequency or frequencies.

Referring again to the examples as shown in FIGS. 3c and 3e, while the sense channels are configured as a spectrum analyzer, no stimulation signal is applied to any of the rows in the touch sensor panel. In the example of FIG. 3c, there are 10 columns and therefore 10 sense channels 350, and three mixers 304 for each sense channel 350, for a total of 30 mixers. In the example of FIG. 3e, there are 10 columns and therefore 10 sense channels 351, and one mixer 304 for each sense channel 351, for a total of 10 mixers. In both examples, the outputs of all amplifier output circuits 309 in every sense channel can be summed together using summing circuit 340, and fed into all mixers 304 through multiplexer or switch 303, which can be configured to select the output of summing circuit 340 instead of charge amplifier 302.

While the sense channels are configured as a spectrum analyzer, the background coupling onto the columns can be measured. Because no Vstim is applied to any row, there is no Csig at any pixel, and any touches on the panel should not affect the noise result (unless the touching finger or other object couples noise onto ground). By adding all outputs of all amplifier output circuits 309 together in adder 340, one digital bitstream can be obtained representing the total noise being received into the touch sensor panel. The frequencies of the noise and the pixels at which the noise is being generated are not known prior to spectrum analysis, but do become known after spectrum analysis has been completed. The pixel at which the noise is being generated is not known and is not recovered after spectrum analysis, but because the bitstream is being used as a general noise collector, they need not be known.

Referring specifically to the example of FIG. 3c, while configured as a spectrum analyzer, the 30 mixers can be used in 15 pairs, each pair demodulating the I and Q signals for 15 different frequencies as generated by NCOs 315. These frequencies can be between 200 kHz and 300 kHz, for example. NCOs 315 can produce a digital rampsine wave that can be used by digital mixers 304 to demodulate the noise output of summing circuit 340. For example, NCO 315_0_A can generate the I component of frequency F0, while NCO 315_0_B can generate the Q component of F0. Similarly, NCO 315_0_C can generate the I component of frequency F1, NCO 315_1_A can generate the Q component of F1, NCO 315_1_B can generate the I component of frequency F2, NCO 315_1_C can generate the Q component of F2, etc.

The output of summing circuit 340 (the noise signal) can then be demodulated by the I and Q components of F0 through F14 using the 15 pairs of mixers. The result of each mixer 304 can be accumulated in accumulators 308. Each accumulator 308 can be a digital register that, over a sample time period, can accumulate (add together) the instantaneous values from mixer 304. At the end of the sample time period, the accumulated value represents the amount of noise signal at that frequency and phase.

The accumulated results of an I and Q demodulation at a particular frequency can represent the amount of content at that frequency that is either in phase or in quadrature. These two values can then be used in magnitude and phase calculation circuit 342 to find the absolute value of the total magnitude (amplitude) at that frequency. A higher magnitude can mean a higher background noise level at that frequency. The magnitude value computed by each magnitude and phase calculation circuit 342 can be saved. Note that without the Q component, noise that was out of phase with the demodulation frequency can remain be undetected.

This entire process can be repeated for 15 different frequencies F15-F29. The saved magnitude values for each of the 30 frequencies can then be compared, and the three frequencies with the lowest magnitude values (and therefore the lowest noise levels), referred to herein as frequencies A, B and C, can be chosen. In general, the number of low noise frequencies chosen can correspond to the number of mixers in each sense channel.

Turning to the example of FIG. 3e, each NCO can provide both phases for I/Q demodulation. This may be accomplished by time multiplexing the phase into the sine lookup table within time period T where T is divided into equal intervals, T0 and T1. During time period T0 the phase into the sine lookup table would come from phase accumulator without modification (0 degr. Phase) and during time period T1 a phase offset equivalent to 90 degr. phase shift would be added to the output of the phase accumulator before the resulting value is passed on to the sine lookup table. Data out of the sine lookup table would appear at twice the demodulation rate. Therefore, the data out of the sine lookup table would have to be de-multiplexed to two ports, e.g. I_NCO and Q_NCO after time T0 and T1, respectively, such that the data at ports I_NCO and Q_NCO would be presented to the I/Q signal mixers at the rate at which amplifier output circuit 309 supplies the data.

Referring to FIG. 3c, when sense channels 350 are configured as panel scan logic, the dashed lines in FIG. 3c can be ignored. At each of Steps 4-19, various phases of the selected low noise frequencies can be used to simultaneously stimulate the rows of the touch sensor panel, and the multiple mixers in each sense channel can be configured to demodulate the sensor signal received from the column connected to each sense channel using the selected low noise frequencies A, B and C. In the example of FIG. 3c, NCO_0_A can generate frequency A, NCO_0_B can generate frequency B, NCO_0_C can generate frequency C, NCO_1_A can generate frequency A, NCO_1_B can generate frequency B, NCO_1_C can generate frequency C, etc. The demodulated signals from each mixer 304 in each sense channel can then be accumulated in accumulators 308, and saved.

In general, the R mixer outputs for any sense channel M (where M=0 to N−1) demodulated by R low noise frequencies F₀, F₁ . . . F_{R-1} can be represented by the notation xF₀S[chM], xF₁S[chM] . . . xF_{R-1}S[chM], where xF₀ represents the output of a mixer demodulated with frequency F₀, xF₁ represents the output of a mixer demodulated with frequency F₁, xF_{R-1} represents the output of a mixer demodulated with frequency F_{R-1}, and S represents the sequence number in the panel scan phase.

Therefore, in Step 4 (representing sequence number 1 in the panel scan phase), and using low noise frequencies A, B and C as the demodulation frequencies, the outputs to be saved can be referred to as xa1[ch0], xb1[ch0], xc1[ch0], xa1[ch1], xb1[ch1], xc1[ch1], . . . xa1[ch9], xb1[ch9], xc1[ch9]. Thus, in the present example, 30 results are saved in Step 4. In Step 5 (representing sequence number 2 in the panel scan phase), the results to be saved can be referred to as xa2[ch0], xb2[ch0], xc2[ch0], xa2[ch1], xb2[ch1], xc2[ch1], . . . xa2[ch9], xb2[ch9], xc2[ch9]. The 30 outputs to be saved in each of Steps 6-19 can be similarly named.

It should be understood that the additional logic outside the sense channels in FIG. 3c can be implemented in the channel scan logic 110 of FIG. 1, although it could also be located elsewhere.

Referring to FIG. 3e, when sense channels 350 are configured as panel scan logic, the dashed lines in FIG. 3e can be ignored. At each of Steps 4-19, various phases of the selected low noise frequencies can be used to simultaneously stimulate the rows of the touch sensor panel, and the mixer in each sense channel can be configured to demodulate the sensor signal received from the column connected to each sense channel using the selected low noise frequencies A, In the example of FIG. 3e, NCOs 315 can generate frequency A. The demodulated signals from mixer 304 in each sense channel can then be accumulated in accumulators 308, and saved.

In general, the mixer output for any sense channel M (where M=0 to N−1) demodulated by one low noise frequencies F₀ can be represented by the notation xF₀S[chM], where xF₀ represents the output of a mixer demodulated with frequency F₀ and S represents the sequence number in the panel scan phase.

Therefore, in Step 4 (representing sequence number 1 in the panel scan phase), and using low noise frequency A as the demodulation frequency, the outputs to be saved can be referred to as xa1[ch0], xa1[ch1], . . . , xa1[ch9]. Thus, in the present example, 10 results are saved in Step 4. In Step 5 (representing sequence number 2 in the panel scan phase), the 10 results to be saved can be referred to as xa2[ch0],xa2[ch1], . . . xa2[ch9] The 10 outputs to be saved in each of Steps 6-19 can be similarly named.

It should be understood that the additional logic outside the sense channels in FIG. 3e can be implemented in the channel scan logic 110 of FIG. 1, although it could also be located elsewhere.

FIG. 4c illustrates an exemplary capacitive scanning plan 410 corresponding to the present example according to embodiments of the invention. FIG. 4c describes Steps 0-19 as shown in FIG. 4b for an exemplary sensor panel having 15 rows R0-R14.

Step 0 can represent the LCD phase at which time the LCD can be updated. The LCD phase can take about 12 ms, during which time no row can be stimulated.

Steps 1-19 can represent the vertical blanking interval for the LCD, during which time the LCD is not changing voltages.

Steps 1-3 can represent the low noise frequency identification phase which can take about 0.6 ms, again during which time no row can be stimulated. In Step 1, the I and Q components of different frequencies ranging from 200 kHz to 300 kHz (separated by at least 10 kHz) can be simultaneously applied to pairs of mixers in the sense channels configured as a spectrum analyzer, and a magnitude of the noise at those frequencies can be saved. In Step 2, the I and Q components of different frequencies ranging from 300 kHz to 400 kHz can be simultaneously applied to pairs of mixers in the sense channels configured as a spectrum analyzer, and a magnitude of the noise at those frequencies can be saved. In Step 3, the lowest noise frequencies A, B and C can be identified by locating the frequencies that produced the lowest saved magnitudes. The identification of the lowest noise frequencies can be done solely on the measured spectra measured in steps 1 and 2, or it can also take into account historical measurements from steps 1 and 2 of previous frames.

Steps 4-19 can represent the panel scan phase which can take about 3.4 ms.

In Step 4, which can take about 0.2 ms, positive and negative phases of A, B and C can be applied to some rows, while other rows can be left unstimulated. It should be understood that +A can represent scan frequency A with a positive phase, −A can represent scan frequency A with a negative phase, +B can represent scan frequency B with a positive phase, −B can represent scan frequency B with a negative phase, +C can represent scan frequency C with a positive phase, and −C can represent scan frequency C with a negative phase. The charge amplifiers in the sense channels coupled to the columns of the sensor panel can detect the total charge coupled onto the column due to the rows being stimulated. The output of each charge amplifier can be demodulated by the three mixers in the sense channel, each mixer receiving either demodulation frequency A, B or C. Results or values xa1, xb1 and xc1 can be obtained and saved, where xa1, xb1 and xc1 are vectors. For example, xa1 can be a vector with 10 values xa1[ch0], xa1[ch1], xa1[ch2] . . . xa1[ch9], xb1 can be a vector with 10 values xb1[ch0], xb1[ch1], xb1[ch2] . . . xb1[ch9], and xc1 can be a vector with 10 values xc1[ch0], xc1 [ch1], xc1 [ch2] . . . xc1 [ch9].

In particular, in Step 4, +A is applied to rows 0, 4, 8 and 12, +B, −B, +B and −B are applied to rows 1, 5, 9 and 13, respectively, +C, −C, +C and −C are applied to rows 2, 6, 10 and 14, respectively, and no stimulation is applied to rows 3, 7, 11 and 15. The sense channel connected to column 0 senses the charge being injected into column 0 from all stimulated rows, at the noted frequencies and phases. The three mixers in the sense channel can now be set to demodulate A, B and C, and three different vector results xa1, xb1 and xc1 can be obtained for the sense channel. Vector xa1, for example, can represent the sum of the charge injected into columns 0-9 at the four rows being stimulated by +A (e.g. rows 0, 4, 8 and 12). Vector xa1 does not provide complete information, however, as the particular row at which a touch occurred is still unknown. In parallel, in the same Step 4, rows 1 and 5 can be stimulated with +B, and rows 9 and 13 can be stimulated with −B, and vector xb1 can represent the sum of the charge injected into columns 0-9 at the rows being stimulated by +B and −B (e.g. rows 1, 5, 9 and 13). In parallel, in the same Step 4, rows 2 and 14 can be stimulated with +C, and rows 6 and 10 can be stimulated with −C, and vector xc1 can represent the sum of the charge injected into columns 0-9 at the rows being stimulated by +C and −C (e.g. rows 2, 6, 10 and 14). Thus, at the conclusion of Step 4, three vectors containing 10 results each, for a total of 30 results, are obtained and stored.

Steps 5-19 are similar to Step 4, except that different phases of A, B and C can be applied to different rows, and different vector results are obtained at each step. At the conclusion of Step 19, a total of 480 results will have been obtained in the example of FIG. 4c. By obtaining the 480 results at each of Steps 4-19, a combinatorial, factorial approach is used wherein incrementally, for each pixel, information is obtained regarding the image of touch for each of the three frequencies A, B and C.

It should be noted that Steps 4-19 illustrate a combination of two features, multi-phase scanning and multi-frequency scanning. Each feature can have its own benefit. Multi-frequency scanning can save time by a factor of three, while multi-phase scanning can provide a better signal-to-noise ratio (SNR) by about a factor of two.

Multi-phase scanning can be employed by simultaneously stimulating most or all of the rows using different phases of multiple frequencies. Multi-phase scanning is described in Applicant's co-pending U.S. application Ser. No. 11/619,433 entitled “Simultaneous Sensing Arrangement,” filed on Jan. 3, 2007 and published as U.S. Published Application No. 2008/0158167 A1 on Jul. 3, 2008, the contents of which are incorporated by reference herein. One benefit of multi-phase scanning is that more information can be obtained from a single panel scan. Multi-phase scanning can achieve a more accurate result because it minimizes the possibility of inaccuracies that can be produced due to certain alignments of the phases of the stimulation frequency and noise.

In addition, multi-frequency scanning can be employed by simultaneously stimulating most or all of the rows using multiple frequencies. As noted above, multi-frequency scanning saves time. For example, in some previous methods, 15 rows can be scanned in 15 steps at frequency A, then the 15 rows can be scanned in 15 steps at frequency B, then the 15 rows can be scanned in 15 steps at frequency C, for a total of 45 steps. However, using multi-frequency scanning as shown in the example of FIG. 4c, only a total of 16 steps (Steps 4 through Step 19) can be required. Multi-frequency in its simplest embodiment can include simultaneously scanning R0 at frequency A, R1 at frequency B, and R2 at frequency C in a first step, then simultaneously scanning R1 at frequency A, R2 at frequency B, and R3 at frequency C in step 2, etc. for a total of 15 steps.

At the conclusion of Steps 4-19, when the 480 results described above have been obtained and stored, additional calculations can be performed utilizing these 480 results.

FIG. 4d illustrates exemplary calculations for a particular channel M to compute full image results at different low noise frequencies corresponding to the present example according to embodiments of the invention. In the present example, for each channel M, where M=0 to 9, the 45 computations shown in FIG. 4d can be performed to obtain a row result for each row and each frequency A, B and C. Each set of 45 computations for each channel can generate a resultant pixel value for the column of pixels associated with that channel. For example, the Row 0, frequency A computation (xa1[chM]+xa2[chM]+xa3[chM]+xa4[chM])/4 can generate the row 0, channel M result for frequency A. In the present example, after all computations have been performed and stored for every channel, a total of 450 results will have been obtained. These computations correspond to Step 20 of FIG. 4b.

Of these 450 results, there will be 150 for frequency A, 150 for frequency B, and 150 for frequency C. The 150 results for a particular frequency represent an image map or image of touch at that frequency because a unique value is provided for each column (i.e. channel) and row intersection. These touch images can then be processed by software that synthesizes the three images and looks at their characteristics to determine which frequencies are inherently noisy and which frequencies are inherently clean. Further processing can then be performed. For example, if all three frequencies A, B and C are all relatively noise-free, the results can be averaged together.

It should be understood that the computations shown in FIGS. 4c and 4d can be performed under control of panel processor 102 or host processor 128 of FIG. 1, although they could also be performed elsewhere.

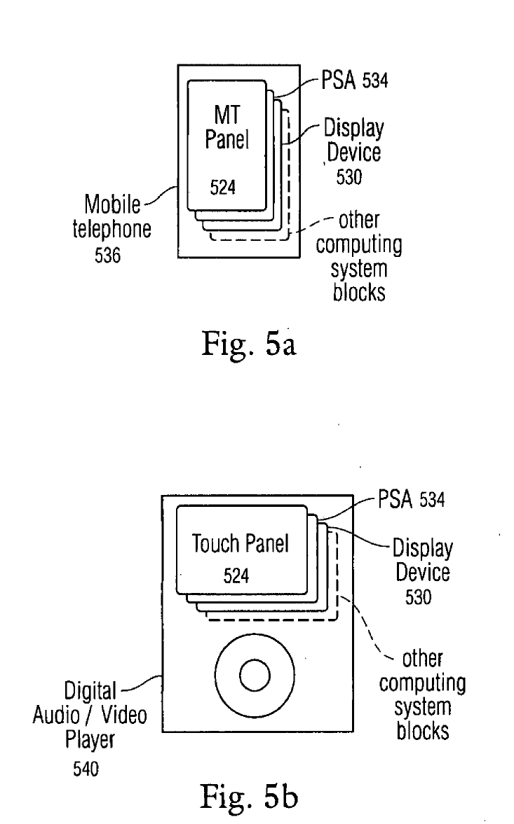

FIG. 5a illustrates an exemplary mobile telephone 536 that can include touch sensor panel 524, display device 530 bonded to the sensor panel using pressure sensitive adhesive (PSA) 534, and other computing system blocks in computing system 100 of FIG. 1 including a single-chip touch controller with an integrated drive system for simultaneously stimulating multiple rows of touch sensor panel 524 with a plurality of stimulation signals according to embodiments of the invention.

FIG. 5b illustrates an exemplary digital audio/video player 540 that can include touch sensor panel 524, display device 530 bonded to the sensor panel using pressure sensitive adhesive (PSA) 534, and other computing system blocks in computing system 100 of FIG. 1 including a single-chip touch controller with an integrated drive system for simultaneously stimulating multiple rows of touch sensor panel 524 with a plurality of stimulation signals according to embodiments of the invention.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. A touch controller for controlling a touch sensor panel, comprising:
a plurality of sense channels that receive sensor signals from the touch sensor panel;
a drive system that generates a plurality of stimulation signals based on a supply voltage on the order of digital logic level supply voltages, the stimulation signals for simultaneously stimulating multiple drive lines of the touch sensor panel; and
a channel controller that controls the sense channels and the drive system;
wherein the plurality of sense channels, the drive system, and the channel controller are formed on a single chip.

2. The touch controller of claim 1, the drive system comprising:
a voltage supply configured for generating a supply voltage that is approximately twice digital logic level voltages.

3. The touch controller of claim 1, wherein the supply voltage for the drive system is provided by an integrated charge pump.

4. The touch controller of claim 3, wherein the charge pump is formed by a standard CMOS ASIC process by cascading two or more transistors.

5. The touch controller of claim 1, wherein the stimulation signals generated by the drive system during a single scan of the touch sensor panel include a signal having a first frequency and a first phase and a signal having the first frequency and a second phase that is 180 degrees from the first phase.

6. The touch controller of claim 1, the drive system configured for generating the plurality of stimulation signals with voltage levels sufficient to produce the sensor signals with a signal-to-noise ratio above a predetermined threshold for obtaining a touch image.

7. The touch controller of claim 1, the drive system configured for generating a plurality of stimulation signals in different patterns during each of multiple scans of the touch sensor panel.

8. The touch controller of claim 1, wherein each sense channel comprises a signal mixer.

9. The touch controller of claim 8, further comprising:
a frequency generator.

10. The touch controller of claim 8, wherein each sense channel further comprises a frequency generator.

11. The touch controller of claim 1, further comprising:
a panel processor that processes a touch image based on the received sensor signals.

12. The touch controller of claim 1, wherein the chip is formed by a complementary metal-oxide-semiconductor (CMOS) manufacturing process.

13. The touch controller of claim 1, wherein the sense channels demodulate the sensor signals to obtain sensor data and the touch controller further comprises:
a processor that processes the sensor data.

14. The touch controller of claim 13, wherein the processor is a dedicated logic device.

15. The touch controller of claim 1, the touch controller incorporated within a computing system.

16. A method for controlling a touch sensor panel using a single chip, comprising:
generating, within the chip, a first plurality of stimulation signals having amplitudes on the order of digital logic level voltages, wherein the stimulation signals are generated in a first pattern for simultaneously stimulating multiple drive lines of the touch sensor panel during a first scan of the touch sensor panel;
wherein the stimulation signal amplitudes are sufficient to produce sensor signals from the touch sensor panel having a signal-to-noise ratio above a predetermined threshold for obtaining a touch image.

17. The method of claim 16, further comprising:
receiving the sensor signals resulting from the first plurality of stimulation signals; and
obtaining a first set of results from the received sensor signals.

18. The method of claim 17, further comprising:
generating multiple other pluralities of stimulation signals having different patterns from the first pattern during other scans of the touch sensor panel;
receiving multiple other sensor signals during the other scans;
obtaining multiple other sets of results from the received multiple other sensor outputs; and
obtaining an image of touch from the sets of results.

19. The method of claim 16, wherein the first plurality of stimulation signals include a signal having a first frequency and a first phase and a signal having the first frequency and a second phase that is 180 degrees from the first phase.

20. A mobile telephone including a touch sensor panel and a touch controller for controlling the touch sensor panel, the touch controller comprising:
a plurality of sense channels that receive sensor signals from the touch sensor panel;
a drive system that generates a plurality of stimulation signals based on a supply voltage on the order of digital logic level supply voltages, the stimulation signals for simultaneously stimulating multiple drive lines of the touch sensor panel; and
a channel controller that controls the sense channels and the drive system;
wherein the plurality of sense channels, the drive system, and the channel controller are formed on a single chip.

21. A digital media player including a touch sensor panel and a touch controller for controlling the touch sensor panel, the touch controller comprising:
a plurality of sense channels that receive sensor signals from the touch sensor panel;
a drive system that generates a plurality of stimulation signals based on a supply voltage on the order of digital logic level supply voltages, the stimulation signals for simultaneously stimulating multiple drive lines of the touch sensor panel; and
a channel controller that controls the sense channels and the drive system;
wherein the plurality of sense channels, the drive system, and the channel controller are formed on a single chip.
